(19) United States
(12) Patent Application Publication
(10) Pub. No.: US 2008/0307512 A1
(43) Pub. Date: Dec. 11, 2008

(54) Property Centric Real Estate Maps with Personalized Points of Interest

(76) Inventor: Pankaj Tandon, Sewickley, PA (US)

Correspondence Address: PANKAJ TANDON, 1636 BLACKBURN HEIGHTS DRIVE, SEWICKLEY, PA, 15143, US

(21) Appl. No.: 12/123,655

(22) Filed: May 20, 2008

Related U.S. Application Data
(63) Continuation of application No. 60/940,402, filed on May 26, 2007.

(51) Int. Cl. H04L 9/32; G06F 3/048

(52) U.S. Cl. 726/4; 715/781; 715/769; 715/780; 726/6

(57) ABSTRACT

This patent describes a method for the Sellers of Real Estate to annotate, personalize and highlight the surroundings of their property-for-sale using graphical icons on a digital map. Potential buyers can view surroundings of Real Estate properties that are so annotated. This method describes a web-based, secure and personalized conduit that is established between the seller and all potential buyers. Also described is the method in which sellers can customize the process of annotating their property so that every subsequent annotation takes less time than the last.

### BACKGROUND OF THE INVENTION

The present invention broadly relates to the field of Web Based Real Estate Searches. As the web becomes more “self-serve” in nature, the gap between the seller and buyer is constantly diminishing. That gap is being replaced by information that is easy to access, changeable and auditable. This invention fulfils that need by providing a method that empowers the Sellers of Real Estate to communicate directly with potential buyers by providing them with personalized text and picture information on a map. The seller and buyer use a direct channel of communication that is secure and auditable. This method can be used to produce a commercial product leveraging this distinct value proposition.

The Real Estate market continues to make inroads into our living rooms via the Internet. The average homebuyer depends more and more on the Internet to begin the search for his home. This usage heralds a robust growth for internet-based tools for the real-estate buyer and seller. This invention provides value in just such a niche by empowering the seller or realtor to showcase the surroundings of his/her property and making good on the real estate mantra of “location, location, location . . . ”

### SUMMARY OF THE INVENTION

As more and more information is syndicated on maps on the Internet, this invention provides a secure and accountable conduit from the seller (or his agent) to the prospective buyer by personalizing the Points of Interest around the property in question.

This personalization is in the form of text and pictures that can be attached to each Point of Interest. The invention also defines a method whereby the act of adding more Points of Interest is made easier by storing a Set of Points of Interest. The invention also defines a method to share this Set of Points of Interest globally, to a targeted audience or with no one (private).

Please see FIGS. 1 thru 8 to better understand the processes that are being claimed by the inventor.

### DETAILED DESCRIPTION

The method described herein describes how a Seller or a Realtor can personalize the surroundings of the Property with the objective of making the Property more attractive to the potential buyers.

The method has some pre-requisites. These pre-requisites are not claimed as a part of the method that is being patented. However, they are required to be in place before the rest of the method (that is being patented) can be carried out. The following are the pre-requisites:
1. The Realtor and Seller must be authenticated users of the website. This means that they must be associated to a valid user Id by which their interaction can be tracked in the website. By doing so, we are ensuring accountability and auditing capabilities.
2. The Realtor can update his/her profile and upload his/her own picture which will be shown next to the surroundings of the Property when it is being marketed.
3. The Realtor can create a Property on the website by entering MLS# and/or the full postal address. The website then determines the location of the Property using the process of Geo-Coding. It then places the Property on a location on the map.

The Realtor can select from a Palette of Icons (that is offered by the website), an icon that represents a certain Point of Interest. For example, if the Realtor knows of a certain restaurant in the vicinity of the Property being sold, s/he will select an icon that represents a Restaurant from the palette and either place it on the map by clicking on a the map, dragging it from the palette to the map, specifying it's postal address or specifying a street intersection.

The realtor can then proceed to annotate the Point Of Interest Icon by adding text to the Point of Interest. The text will comprise a name of the Restaurant, description of the Restaurant, a URL for the web address of the restaurant and a phone number. S/he can also upload pictures of the Restaurant.

It is possible that the Realtor may not know of all Points of Interest in the vicinity of the Property being sold. In that case, s/he may decide to invite the Seller to annotate the Property and/or correct information about the Points of Interest that have already been added.

To invite the Seller, s/he will need to supply a user Id and password combination. The website will ensure that the user Id selected is unique (and if not will prompt the Realtor to select another one). When the Realtor instructs the website to invite the Seller, the website will:
1. Create a new account for the Seller
2. Assign the Seller to the Property being annotated
3. Send out an email to the Seller (to the email address supplied by the Realtor) inviting him/her to log on to the website and annotate the surroundings of this property.

When the Seller logs on using the user id and password specified in the email (and supplied by the realtor), s/he will be prompted by the website to change his/her password. He will be shown a list of Properties that he is allowed to annotate. The list will usually consist of only those properties that are assigned to the seller and will usually be only one. When s/he clicks on the Property, s/he will be shown a digital map of the property where the following actions can be taken:
1. Point of Interest can be added
2. Existing Points of Interests can be relocated.
3. Point of Interest can be deleted
4. Photos can be added or deleted to existing Points of Interest
5. Text of existing Points of Interest can be edited.

The Realtor can also log on to the website and by doing so, have access to all the Points of Interest that the Seller may have added. At this time s/he (the Realtor) can decide to create a Set of Points of Interest that s/he can name based on the area/neighborhood that that Property exists in. This process involves copying a set of Points of Interest that surround one or more properties to a new or existing Set. The website will determine what Points of Interest are duplicate and will prevent copying of existing Points of Interest. The Set so created can be granted Global, restricted or local access. Global Access will give any user of the website access to Points of Interest in this Set. Restricted Access will require the Realtor to specify a user of the website who can have access to the website. Local access will give access to only the Realtor and all the Seller accounts that he has created or will create in the future.

When a Seller logs in to a website s/he can import Points of interest from all sets of Points of Interest that are available to him/her. S/he can access Points from a Set by specifying a Set name (for example North Shore) or by distance (get me all Points within 10 miles of the Property).

Sellers and Realtors can use the above method of Importing Points of Interest. It therefore makes the process of adding Points of Interest incrementally easier (requiring less user input) as the number of Properties (that are being annotated) increases.

Note that once a Point of Interest Set is created, a Seller can gain access to it immediately. In fact, all changes to the surroundings of a Property are available immediately to Sellers, Realtors and potential buyers.

Also Note that once Points are copied from a Set into the vicinity of a Property, it is no longer associated to the Set. So any changes made to the Point of Interest after it is imported does not reflect in the “original” point in the Set.

At anytime after creating the Property, the website offers a unique URL (web address) that shows the surroundings of the property in question. The Realtor can publish this web address to any Real Estate Search site that shows lists of Properties.

Potential Buyers can click on the published URL to see the surroundings of the property in question. Note that the buyers do not have to explicitly visit the website to view surroundings. Rather they visit Real Estate Search sites that have the web address of the surroundings published to them.

Potential Buyers can also search the website for Properties that are in the vicinity of certain Points of Interest. The website's database maintains the distance of each Point of Interest from Property. This information can be used to search for Properties that are a specified distance from a Point of Interest.

### BRIEF DESCRIPTION OF THE DRAWINGS

FIG. 1: User Interaction Diagram: This figure shows the activities that the three users of the website carry out.

FIG. 2: This is a flow diagram of the detailed activity of a Realtor.

FIG. 3: This is a flow diagram of the detailed activity of a Seller.

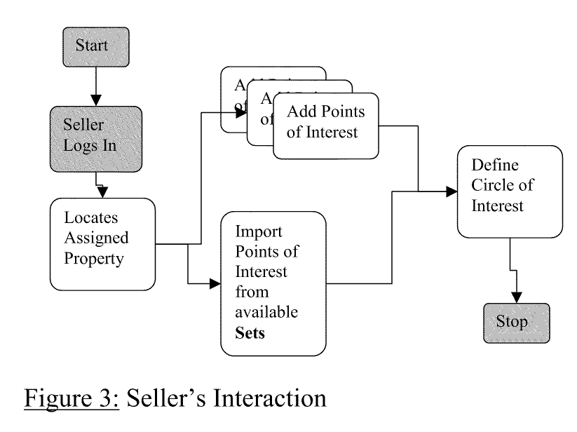

FIG. 4: This is a flow diagram of the detailed activity of a Buyer.

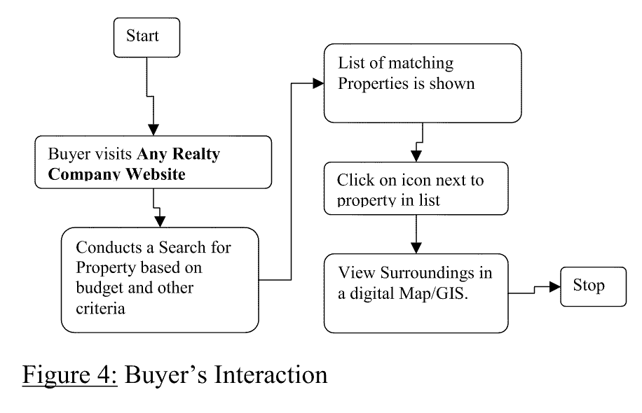

FIG. 5: This figure shows one possible implementation of how Points of Interest can be added to a map, by selecting from a palette.

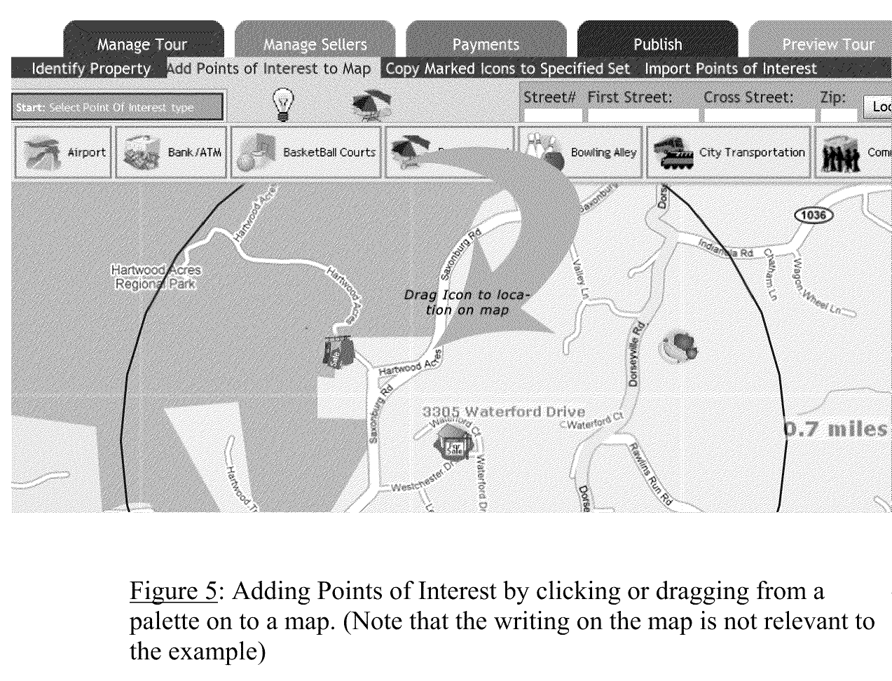

FIG. 6: This figure shows one possible implementation of how Points of Interest can be added to a map by specifying a street intersection.

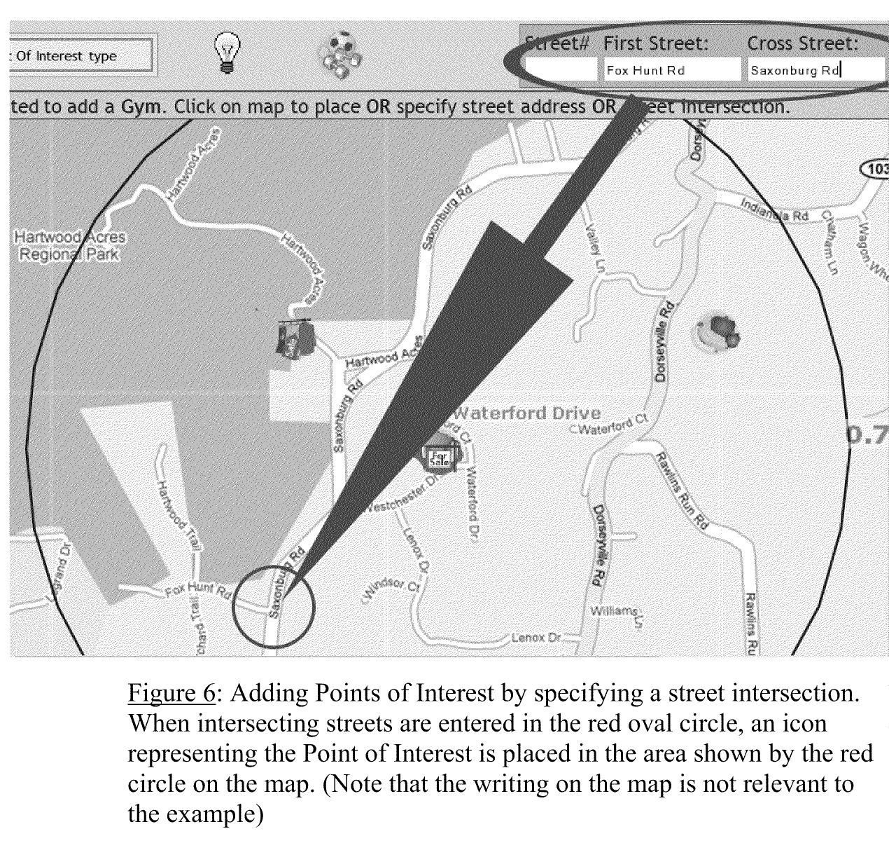

FIG. 7: This figure shows what the Buyer will see when s/he clicks on an icon that represents the website. What is shown are the surroundings of the Property and a Circle of Interest, which allows the Buyer to focus on icons and features that the Seller/Realtor want the Buyer to see.

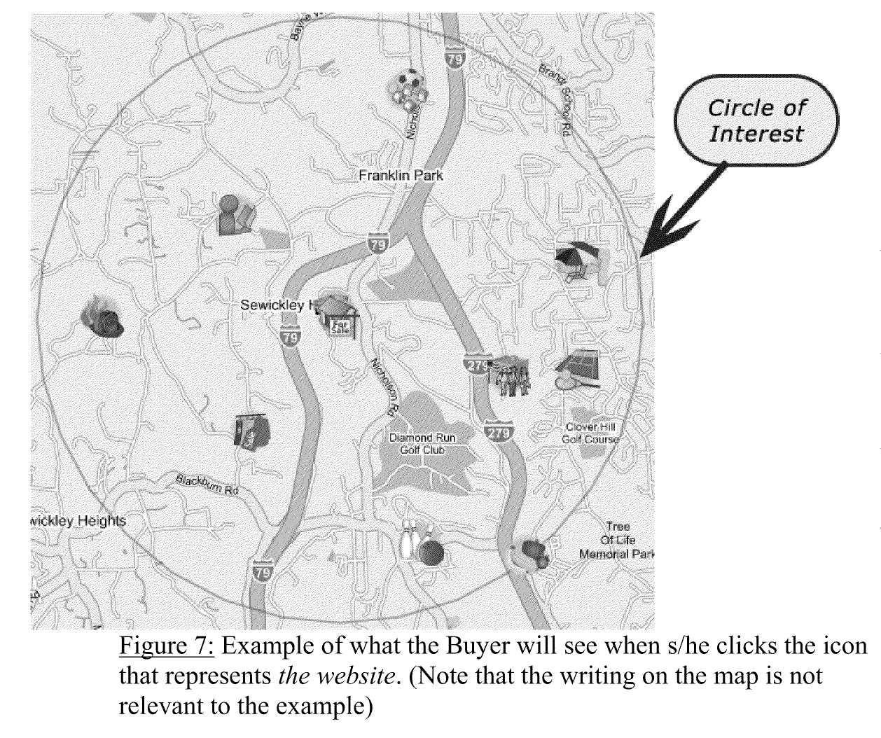

FIG. 8: This figure shows what the potential Buyer will see when s/he clicks on an icon representing a Point of Interest. The text shown is personalized for this Point of Interest and entered by the Seller.

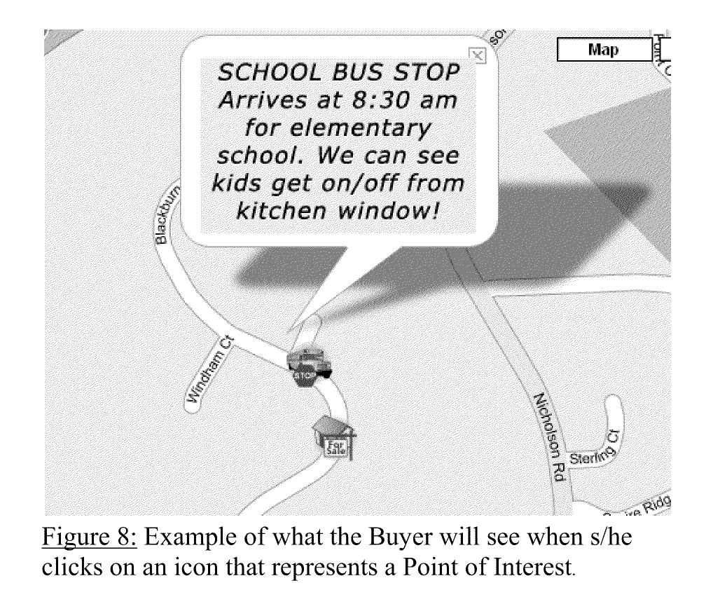

In addition to above, the following are some of the benefits of this invention:

### Immediate Access:

The Internet allows us to have information at our fingertips. In keeping with this feature of the internet, this method allows sellers to not only annotate surroundings of property via a secure account, it allows them to do so in real-time; the information they enter is available immediately to potential buyers. Also, a secure user account enables the Property to be annotated at any time over several weeks or months during the time the Property is for sale. This gives the Realtor to add/modify/delete the surroundings of the Property as and when he/she recollects unique Points of Interest that surround their Property.

### Accountability:

In an environment where information can freely be entered by registered users, it is very important to audit who entered what and when. This business method tracks all data and digital photo entry and displays it so that the electronic trail of data is displayed for authorized users.

### Monitoring:

The method allows registered users to enter data. The nature of that data itself cannot be monitored by the computer information system. This method recommends a web page that can be used by a human to read and process data and pictures and deem them appropriate for use so and flag them as such. Any modification to the text or picture information will again subject them to human scrutiny till such time they are flagged.

### CONCLUSION

This invention provides a distinct value proposition by personalizing the real estate buying and selling experience and leveraging the power of the Internet and digital mapping solutions.

I claim:

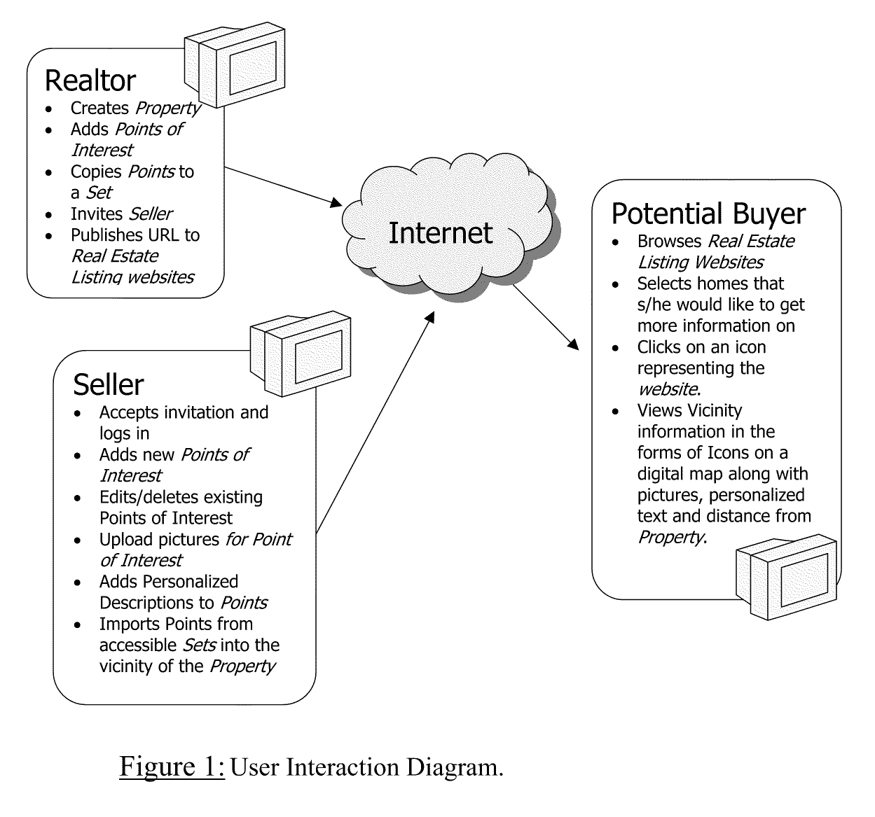

1. Complete Business Method: A method where a Realtor can access the website, create a Property that he/she represents, add Points of Interest, create a Seller Account, Invite the Seller Account holder to add Points Of Interest, edit, his/her Properties and/or Points of Interest previously entered, create/modify or delete a Point of Interest Set, import Points of Interest from a Point Of Interest Set into a Property that he/she is editing, adjust the Circle of Interest of the Property, pay for the property by being invoiced or via a credit-card, publish the property to other sites, re-list the Property and view Reports. A high-level process flow can be seen in FIG. 1.

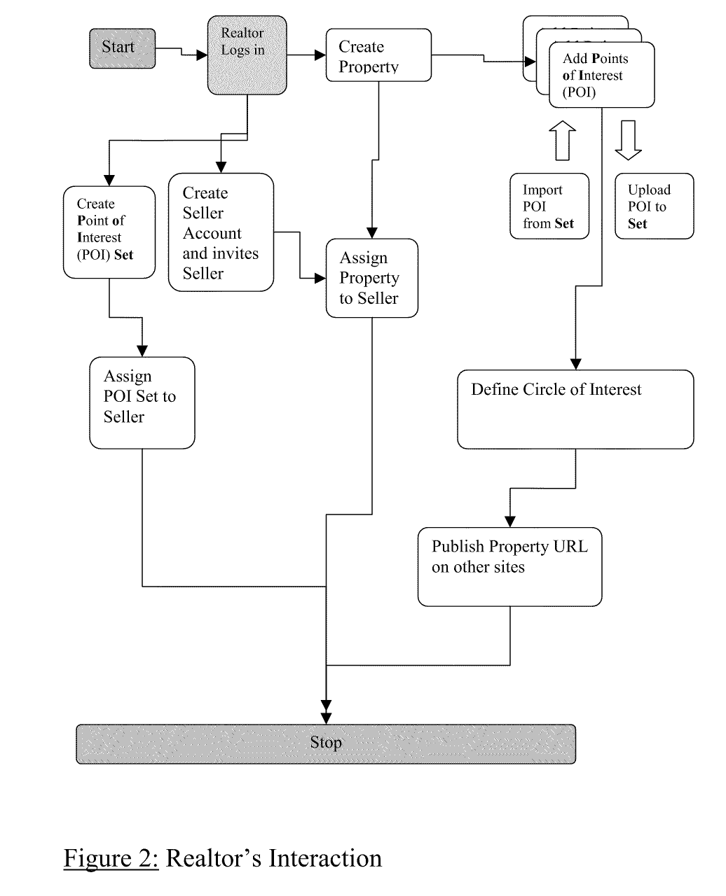

2. Property Creation Method: Further to what is claimed above, a method whereby Property(ies) can be created on the website by Realtors. A new Property can be listed with the MLS, or could be an FSBO. This method establishes a PropertyId associated to the Property and stores it in a database. See FIG. 2.
a. A method where the website can GeoCode the Property when the Realtor supplies the postal address. The postal address can be any valid street address in North America. This claim does NOT claim rights to the process of GeoCoding itself, but to the process of the website using the GeoCoding process to arrive at the Latitude-Longitude of the Property and storing the Latitude/Longitude in a database against this propertyId.
b. A method whereby the Realtor can add a description, price and additional URLs to the Property.
c. A method whereby the Realtor can upload photos against this PropertyId. Additionally:
i. The method where the website will allow each photo be annotated with descriptions.
ii. The method where the website will allow for deleting pictures that are already uploaded.
iii. A method where the website will show thumbnail images of photos already uploaded so that the user may decide to view/delete already uploaded pictures.

3. Seller Account Management Method: A method where the Realtor can optionally create a Seller Account. A Seller Account may be created by the Realtor when he/she would like someone else (other than himself/herself) to add Points of Interest to this Property.
a. A method where the Realtor can assign the property to this Seller Account. This method ensures that Seller Account holders can only access Property(ies) that are they have been assigned to and not all the Properties that are being managed by this Realtor.
b. A method by which the Realtor can access and search for Seller Accounts that he/she may have created earlier on to maintain and/or delete them or to assign/revoke properties that may have been assigned to this Seller Account.
c. A method where the Realtor can assign a Point of Interest Set to a Seller Account for him/her to use while adding or modifying Points Of Interest for a certain assigned Property.

4. Seller Invitation Method: A method where the Realtor can invite the Seller Account holder to add points of interest to Property(ies) that are assigned to him/her.
a. A method which shows to the Realtor all Seller Accounts that he/she may have created and displays to the Realtor the invite that will be sent out to an editable list of email addresses, initialized to the email address of the Seller Account holder.
b. A method which will allow the Realtor to add text to the pre-set email that is sent out as a part of the invite.

5. Seller Account Re-Invite Method: A method where the Realtor can re-invite a Seller Account holder to add Points of Interest to a Property he/she may be previously assigned to. This is necessary if the Seller Account holder has misplaced his/her previous invite thereby forgetting the credentials to log into the website with.
a. Further to the above claim, a method where the last sent email date and email address(s) are shown to the Realtor.
b. Further to above claim, the method by which a separate email address can be supplied by the Realtor to send out the invite.
c. Further to above claim, the method by which the credentials with which the Seller Account was created is added to the email.
d. Further to above claim, the method by which a customized message can be added to the invite.

6. Seller Account Access Method: A method where the Seller Account holder can login to the website using credentials emailed to him/her as per the invite sent in the method described in claim Seller Invitation Method or Seller Account Re-Invite Method.

7. Point of Interest Management Method: A method where the Seller Account holder and/or the Realtor can jointly add/modify or delete Points of Interest to the property(ies) that have been assigned to him/her as below (See FIG. 2):
a. Select a Property to annotate (assign Points of Interest to).
b. Select a Point of Interest from a palette of icons that represent these Points of Interest (for example: a park, library or gym etc). Selection of a Point of Interest will implicitly tie this Point of Interest to the selected Property.
c. Personalize the name of the Point of Interest by giving it a name (for example a Point of Interest representing a park could be called “Harris Park”).
d. Geo-code the point of interest using either of the two methods below:
i. Enter the postal address of the Point of interest and have the website Geo-code the Point of Interest.
ii. Click on the location of the Point of Interest on a map and have the website geo-code that location.
e. Add/modify or delete a text description of Points of Interest including adding URLs for each Point of Interest.
f. Uploading digital pictures (photographs) against the current Point of Interest and giving each a description as described in Property Creation Method, sub point c.
g. Import a Point Of Interest Set from his/her own (previously created) Point of Interest Set or from all the Point Of Interest Sets assigned to him/her. This will create all the Points of Interest in that set to the Property being annotated in one fell swoop. Imported Points of Interest can be “Adjusted” as described in Adjust Surroundings Method/Adjust Circle of Interest Method. Imports can be done in one of 3 ways:
i. Import the Points of Interest location and Name only.
ii. Import as above plus the description associated to each Point of Interest.
iii. Import as above plus any digital pictures associated to the Point of Interest.
h. Add the current Points of Interest to an existing Point of Interest Set without having to define a new Point Of Interest Set.
i. Having the website issue a warning if the Points of Interest Set already holds some Points of Interest that are equivalent as described in Point of Interest Equivalency Method.
i. The website gives the option to create a new Point of Interest Set consisting of the current Points of Interest in the Property.
j. Subsequently modify the Points Of Interest recorded against this Property without modifying the Points of Interest in the original Point Of Interest Set.

8. Point of Interest Set Management Method: A method where the Realtor can manage (add/modify/delete) the Point Of Interest Set for future use with other Properties.
a. The Point of Interest Set will be created and managed by the Realtor and is potentially assignable to a Seller Account holder. It is available to both for future use.
b. The Point of Interest Set will consist of a short and a long description that is used to search for this Point Of Interest Set when there are several to choose from (per Realtor).
c. The Point of Interest Set may be assigned to (or revoked from) a Seller Account for him/her to use while annotating the Property (that is being jointly) annotated).
d. A Point Of Interest Set can be assigned to any valid and active user of the website. By being so assigned, the valid user will be able to import this Point of Interest Set when annotating his/her properties.
e. A method where Points of Interest may be deleted or modified in any Point of Interest Set and not affect any Property's Points of Interest, where this Set may have been imported and used previously. Conversely, future imports of the modified Point of Interest Set would carry the modifications.
f. A method where the Realtor can move Points of Interest from one Point of Interest Set to another.
g. A method where the Realtor can search a Point of Interest Set from several sets that have been saved by him/her in the past or from those that have been assigned to him/her.
h. A method where Points of Interest may be added or deleted (from a Point of Interest Set) just like Points of Interest are added to a Property as described in claim Point of Interest Management Method.
i. A method where the Point of Interest Set can be marked global, restricted or local.
i. Global Point of Interest Sets are available to all users of the website for potential import when they are annotating their properties.
ii. Restricted Point of Interest Sets are available to only those users to whom they have been explicitly assigned.
iii. Local Point Of Interest Sets are available only to the user who created them.

9. Point of Interest Equivalency Method: This method describes how it is determined that 2 or more Points of Interest that exist in one or more Point of Interest Sets are equivalent to each other.
a. Further to the above claim, this method determines that because two (or more) Points of Interest are equivalent, they are not candidates for export into a Point Of Interest Set in which they already exist.
b. Further to the above claim, the equivalency of Points Of Interest can cause these points to behave differently when importing into a Property.

10. Geographical Centering Method: A method to compute the geographical center of a Point Of Interest Set. The geographical center is used to determine which globally accessible Point of Interest Sets are potential candidates for imports by users as described in the Point Proximity Method.

11. Point Proximity Method: A method to identify all:
a. Point of Interest Sets that fall within a given distance from any point.
b. Points of Interest that fall within a given distance from any point.
c. A method to display the number of Points Of Interest that fall within a certain distance from a given point.

12. Point of Interest Set Portability Method: A method whereby a Point of Interest Set can be exported stored and emailed in XML format. The XML file that represents the Point Of Interest Set can then be imported by potential users. This method does not require that the Point of Interest Set have an accessibility level of ‘global’ and provides a means for sharing Point of Interest Sets with other users of the website.

13. Adjust Surroundings Method/Adjust Circle of Interest Method: A method where the Realtor, during the time he/she is adding Points of Interest, can adjust the Circle of Interest and all Points of Interest on a map. The Points of Interest are available on the map by either of the two methods below:
a. Creating them one-by-one via the Point of Interest Management Method section described above.
b. Importing a Point of Interest Set as described in Point of Interest Management Method section under the Import sub tab.
In both cases this method specifies how Points of Interest are presented to the user to be either included (enabled) or excluded (disabled) from the Circle Of Interest.
a. As Points of Interest are enabled, the Circle of Interest expands or contracts to include the farthest enabled Point of Interest from the Property.
b. The following operations can be carried out on each Points of Interest that is shown on the map in this method:
i. Deleted: The Point of Interest is deleted from the surroundings of this Property.
ii. Copied: The Point of Interest is copied to a Point of Interest Set but left on the surroundings of this Property.
iii. Moved: The Point of Interest is moved to a different Point of Interest Set and removed from the surroundings of this Property.
c. Save the Adjusted surroundings so that all enabled Points of Interest are saved against this Property and are available within the Circle of Interest.

14. View Surroundings Information in Map Method: A method that makes the surroundings of a Property viewable on a digital map by clicking on a URL (web address) that is unique for each Property.
a. Further to above, the method to make each icon on the map click-able to reveal more information about that Point of Interest and/or Property in text form, URLs and/or Photographs.

15. View Surroundings In GIS Browser Method: A method where the surroundings of a Property can be viewed from a GIS browser in a manner similar to what is described under View Surroundings Information in Map Method.

16. Publishing Method: A method where the Realtor can publish the Property by providing the URL (web address) of the surroundings of the Property (hosted on the website) on other websites.
a. The method by which a unique URL (web address) is generated for every Property.
b. A method whereby a request to publish can be sent via the website so that the unique URL is placed on other sites along with the icon for the website.

17. Track Publishing Method: A method for the Realtor to track if the property has been published on any other website or not.
a. Further to above, a method to record text where the Realtor can store information outlining where the Property was published.
b. A method to show the Realtor information about where a Property has been Published.

18. Re-Listing Method: A method where the Realtor can re-list a home by assigning the property a different MLS number. This method is applicable only for properties that are listed with the MLS, not for FSBO properties. The website will associate the new MLS number to the original MLS number and maintain that association, thereby obviating the need to change the web address (URL) of all previously published links (on other sites) because those links refer to the old MLS number.

19. Proximity Search Method: A method Buyers can access the website without needing to login and conduct Proximity Searches of Real Estate.
a. A method where buyers access the database of the website and locate Properties that fall within a given distance from specified Points of Interest.
b. A method where all results of Proximity Searches of Real Estate that are shown in list form can be shown on one map all at once using icons. Buyers (and/or Realtors) can then click on the icons to get more information (including surrounding information) on each Property.

20. Data Monitoring Method: A method where all un-flagged text and picture information is scrutinized by a human reader to deem fit for posting. Once such information is flagged as having passed, it drops off the list of scrutiny till it is modified or new information is added.
a. Further to what is claimed above, a method to show all user entered information including text and photos.
b. Further to what is claimed above, a method that will flag a user input (text or Photo) that has already been scrutinized and validated into a “Pass” status, to be placed back into a “Fail” status as soon as it is modified. This will cause this user input to be subject to scrutiny via the monitoring process.
c. Further to what is claimed above, a method to validate/pass a certain batch of pictures and text so that it is flagged as validated/passed.
d. Further to what is claimed above, a method to retrieve text and photo information that is not flagged.
e. Further to what is claimed above, a method to inform the user of account suspension as a result of scrutinizing the information and finding it not meeting a pre-defined standard.

21. Batch Upload Method: A method where batches of Properties can be uploaded to the website without human intervention which obviates the need for a physical person to go through the 6-step-wizard to create a Property as described in Property Creation Method.
a. Further to what is claimed above, a method to receive Property information including MLS number, address, Realtor representing the Property, cost, description and date listed into a staging area.
b. Further to what is claimed above, a method to automatically create a user of the website based on the information read into the staging area and if that user is not already created.
c. Further to what is claimed above, a method to automatically create Properties with attributes as stored in the staging area in the database of the website. Also, at the time of creation, automatically geo-coding the properties.
d. Further to what is claimed above, a method to send out email to that user inviting him/her to access the website and view/modify/enhance the Properties that have been created via a batch process under his/her account.

22. View Hit-Count Method: A method where the website can track the number of times a certain property has been viewed and from what locations has it been viewed.
a. Further claimed that this information is available to Realtors and Sellers upon logging into their account on the website.
b. Further claimed that this method outlines how this information is broken down by the location the surrounding data has been viewed from.
c. Further claimed that this information is available via email if they have supplied a valid email address at the time of registration (of their web account) and have indicated a preference to receive such information in their user profile at a later time.

23. Surroundings Propagation Method: Buyers in their search for Real Estate may visit some other real estate website and conduct searches there. When the result is presented to them, this method specifies how an icon (that represents the website) can be placed alongside the search results and offers the Buyer a means to view the surroundings of the Property by clicking on it.
a. Further claimed that by doing so, the Buyer can view the surroundings of the Property in a digital map and in a GIS Browser, both with the capability to zoom and pan.
b. Further claimed that by doing so, the Buyer can click on the icons and view the Linear Distance of the Point of Interest from the Property.
c. Further claimed that by doing so, the Buyer can click on icons on the map and the GIS Browser and view text and photo information that the Realtor and/or Seller Account holder had previously entered at the website.
d. Further claimed that by doing so, the Buyer can email the link (web address) of this map (with this Property 's surroundings) to any valid email address along with a customized message.
